(19) United States
(12) Patent Application Publication
(10) Pub. No.: US 2026/0301454 A1
(43) Pub. Date: Oct. 1, 2026

(54) METHOD AND SYSTEM FOR DETERMINING SIMILARITY BETWEEN SENTENCES USING PAIR-WISE DIVERGENCE MATRIX

(71) Applicant: HCL Technologies Limited, New Delhi (IN)

(72) Inventors: Mallamgari Nithin Reddy, Bengaluru (IN); Vedasamhitha Challapalli, Bengaluru (IN); Rupesh Prasad, Bengaluru (IN); Atul Singh, Bengaluru (IN); Arvind Maurya, Noida (IN)

(21) Appl. No.: 19/440,735

(22) Filed: Jan. 6, 2026

(30) Foreign Application Priority Data
Mar. 27, 2025 (IN) 202511029032

(51) Int. Cl. G06V 30/19

(52) U.S. Cl. CPC G06V 30/19093; G06V 30/19073

(57) ABSTRACT

A method and system for determining similarity between sentences using a pair-wise divergence matrix is disclosed. The method includes computing, by a processor, a pair-wise divergence value of each word of a first sentence relative to each word of a second sentence using an F-divergence method selected from a plurality of F-divergence methods. Further, the pair-wise divergence value is computed using a probability distribution of each word of the first sentence relative to each word of the second sentence. The method further includes creating, by the processor, a pair-wise divergence matrix based on the computed pair-wise divergence values. The method further includes calculating, by the processor, a similarity score between the first sentence and the second sentence based on the pair-wise divergence matrix.

### TECHNICAL FIELD

This disclosure generally relates to determining similarity between sentences and more particularly, to a method and system for determining similarity between sentences using a pair-wise divergence matrix.

### BACKGROUND

Determining similarity between documents or sentences therein is required to accurately retrieve desired information from large databases or from the cloud. Search engines employ various similarity-checking techniques for accurate information retrieval without requiring specific or special inputs from an end user. However, most of the existing techniques for determining a similarity perform well with simple cases but fall short in case of presence of noise. Moreover, most of the existing solutions are only limited to checking for lexical similarity but lack in checking semantic similarity.

Some of the existing solutions for measuring similarity between sentences are based on vectors and angular distances between the words contained therein. These approaches work well in simple cases, but are sensitive to noise, for example, unnecessary characters or slight changes in lexicon. Such noise may change the result of the vector's approach significantly and give inaccurate results.

Therefore, there is a requirement for an optimal methodology to measure similarity between sentences with high accuracy.

### SUMMARY OF THE INVENTION

In an embodiment, a method for determining similarity between sentences using a pair-wise divergence matrix is disclosed. The method may include computing, by a processor, a pair-wise divergence value of each word of a first sentence relative to each word of a second sentence using an F-divergence method selected from a plurality of F-divergence methods. It should be noted that the pair-wise divergence value is computed using a probability distribution of each word of the first sentence relative to each word of the second sentence. The method may further include creating by the processor, a pair-wise divergence matrix based on the computed pair-wise divergence values of each word of the first sentence relative to each word of the second sentence. The method may further include calculating, by the processor, a similarity score between the first sentence and the second sentence based on the pair-wise divergence matrix.

In another embodiment, a system for determining the similarity between sentences using a pair-wise divergence matrix is disclosed. The system may include a processor, and a memory communicably coupled to the processor, wherein the memory stores processor-executable instructions, which when executed by the processor, cause the processor to compute a pair-wise divergence value of each word of a first sentence relative to each word of a second sentence using an F-divergence method selected from a plurality of F-divergence methods. It should be noted that the pair-wise divergence value is computed using a probability distribution of each word of the first sentence relative to each word of the second sentence. The processor may be further configured to create a pair-wise divergence matrix based on the computed pair-wise divergence values of each word of the first sentence relative to each word of the second sentence. The processor may be further configured to calculate a similarity score between the first sentence and the second sentence based on the pair-wise divergence matrix.

It is to be understood that the foregoing general description and the following detailed description are exemplary and explanatory only and are not restrictive of the invention, as claimed.

### BRIEF DESCRIPTION OF DRAWINGS

The accompanying drawings, which are incorporated in and constitute a part of this disclosure, illustrate exemplary embodiments and, together with the description, serve to explain the disclosed principles.

FIG. 1 illustrates a functional block diagram of an exemplary system for determining similarity between sentences using a pair-wise divergence matrix, in accordance with an embodiment of the present disclosure.

FIG. 2 illustrates a functional block diagram of various modules within a memory of a computing device configured to determine similarity between sentences using a pair-wise divergence matrix, in accordance with an exemplary embodiment of the present disclosure.

FIG. 3 illustrates word embeddings and probability distribution for two sentences, in accordance with an exemplary embodiment of the present disclosure.

FIGS. 4A-B illustrate a pair-wise divergence matrix created for two sentences, in accordance with an exemplary embodiment of the present disclosure.

FIG. 5 illustrates a flowchart of a method for determining similarity between sentences using a pair-wise divergence matrix, in accordance with an exemplary embodiment of the present disclosure.

FIG. 6 illustrates another flowchart of a method of determining similarity between sentences using a pair-wise divergence matrix, in accordance with an exemplary embodiment of the present disclosure.

FIG. 7 illustrates a flowchart of a method of calculating a similarity score between two sentences, in accordance with an exemplary embodiment of the present disclosure.

FIG. 8 illustrates a flow diagram of a method of selecting an F-divergence method from a plurality of the F-divergence methods, in accordance with an exemplary embodiment of the present disclosure.

### DETAILED DESCRIPTION OF THE DRAWINGS

Exemplary embodiments are described with reference to the accompanying drawings. Whenever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered exemplary only, with the true scope being indicated by the following claims. Additional illustrative embodiments are listed below.

Further, the phrases “in some embodiments”, “in accordance with some embodiments”, “in the embodiments shown”, “in other embodiments”, and the like, mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope and spirit being indicated by the following claims.

Typically, the existing methods of similarity determination in sentences such as cosine similarity are based on vector spaces and angular distances between embeddings. Although these approaches work well for simple cases, they are sensitive to noise like unnecessary characters or slight changes in the lexicon that can change sentence embedding significantly. This constraint is especially evident in high-dimensional embedding spaces because a single change can alter multiple dimensions.

Accordingly, the present disclosure provides a method and system for determining the similarity between sentences using a pair-wise divergence matrix.

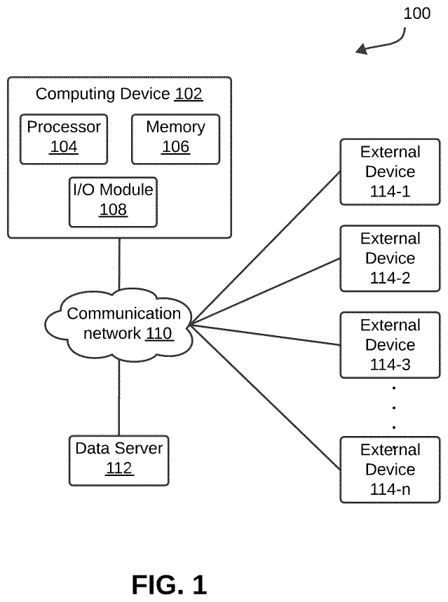

Referring now to FIG. 1, a functional block diagram 100 of an exemplary system for determining similarity between sentences using a pair-wise divergence matrix is illustrated, in accordance with an embodiment of the present disclosure. The system 100 may include a computing device 102 that may be configured to determine the similarity between sentences using a pair-wise divergence matrix. The computing device 102 may be configured to perform a plurality of functions such as receiving input from a user and processing the received input in order to provide expected output. The computing device 102, for example, may be one of, but is not limited to a smartphone, a laptop computer, a desktop computer, a notebook, a workstation, a server, a portable computer, a handheld, or a mobile device. The computing device 102 may include a processor 104 and a memory 106. Examples of processor 104 may include but are not limited to, an Intel® Itanium® or Itanium 2 processor, or AMD® Opteron® or Athlon MP® processor, Motorola® lines of processors, Nvidia®, FortiSOC™ system on a chip processors or other future processors. Further, the memory 106 may store instructions that, when executed by the processor 104, cause the processor 104 to determine similarity between one or more sentences using a pair-wise divergence matrix, as will be discussed in greater detail below. In an embodiment, the memory 106 may be a non-volatile memory or a volatile memory. Examples of non-volatile memory may include but are not limited to flash memory, Read Only Memory (ROM), Programmable ROM (PROM), Erasable PROM (EPROM), and Electrically EPROM (EEPROM) memory. Further, examples of volatile memory may include but are not limited to Dynamic Random Access Memory (DRAM), and Static Random-Access Memory (SRAM).

The computing device 102 may also include an I/O (Input/Output) module 108. The I/O module 108 may include variety of interface(s), for example, interfaces for data input and output devices, and the like. The I/O module 108 may facilitate inputting of instructions by a user communicating with the computing device 102. In an embodiment, the I/O module 108 may be connected to a communication pathway for one or more components of the computing device 102 to facilitate the transmission of inputted instructions and output results of data generated by various components such as, but not limited to, the processor 104 and the memory 106.

The computing device 102 may be communicatively coupled to a data server 112 and a plurality of external devices 114a-114n through a communication network 110. The external devices 114a-114n, for example, may be, but are not limited to a smartphone, a laptop computer, a desktop computer, a notebook, a workstation, a server, a portable computer, a handheld, or a mobile device. The communication network 110 may be a wired or a wireless network or a combination thereof. The communication network 110 can be implemented as one of the different types of networks, such as but not limited to, ethernet IP network, intranet, local area network (LAN), wide area network (WAN), the internet, Wi-Fi, LTE network, CDMA network, 5G and the like. Further, the communication network 110 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the communication network 110 may include a variety of network devices, including routers, bridges, servers, computing devices, storage devices, and the like.

In an embodiment, the data server 112 may be enabled in a remote cloud server or a co-located server and may include a database to store an application, and other data necessary for the system 100 to perform similarity determination between sentences. In an embodiment, the data server 112 may store data input by one of the external devices 114a-114n (for example, documents or images) or output generated by the computing device 102 (for example, similarity index with respect to document/sentences). It is to be noted that the application may be designed and implemented as either a web application or a software application. The web application may be developed using a variety of technologies such as Hyper Text Markup Language (HTML), CSS, JavaScript, and various web frameworks like React, Angular, or Vue.js. It may be hosted on a web server and may be accessible through standard web browsers. On the other hand, the software application may be a standalone program installed on users' devices, which may be developed using programming languages such as Java, C++, Python, or any other suitable language depending on the platform. In an embodiment, the computing device 102 may be communicably coupled with the data server 112 through the communication network 110.

In some embodiments, the computing device 102 may receive a user input for determining similarity between sentences from one or more of the external devices 114a-114n through the communication network 110. The computing device 102 may use a pair-wise divergence matrix to determine similarity between the sentences.

The computing device 102 may use a pair-wise divergence matrix to determine similarity between the sentences. The computing device 102 may perform various functions in order to determine similarity between the sentences using the pair-wise divergence matrix. By way of an example, the computing device 102 may receive two or more sentences as input either from the I/O module 108 or from one of the external devices 114-a to 114-n. For example, a user may type the sentences using a user input interface or indicate a file path for the application via the I/O module 108. In an embodiment, the similarity determination function or application may undergo similarity determination testing to ensure its performance under various conditions. One example of at least one testing scenario may include performing similarity determination between sentences having extra and unnecessary characters and/or synonyms included in the sentences to ensure the semantic meaning is also being compared in order to check the similarity between two sentences, as will be discussed in greater detail herein below.

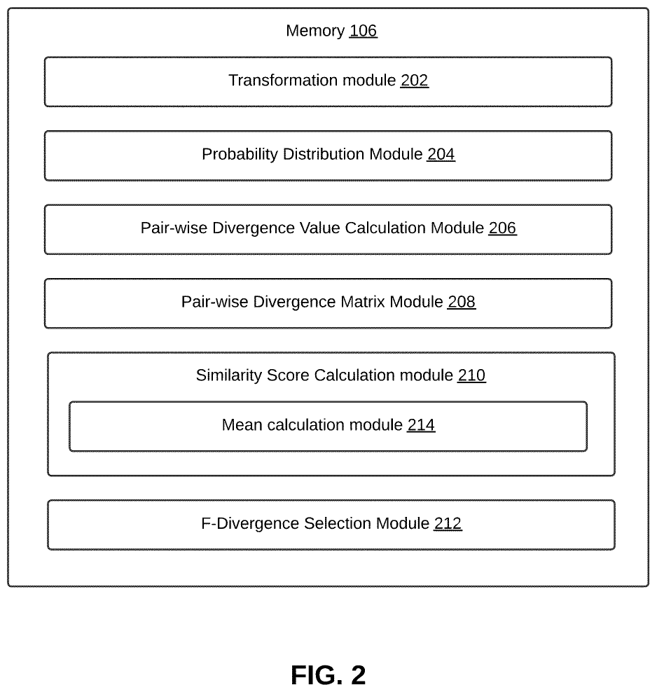

Referring now to FIG. 2, a functional block diagram 200 of various modules within the memory 106 of the computing device 102 configured to determine similarity between sentences using a pair-wise divergence matrix is illustrated, in accordance with an exemplary embodiment of the present disclosure. In an embodiment, the memory 106 may include a transformation module 202, a probability distribution module 204, a pair-wise divergence value calculation module 206, a pair-wise divergence matrix module 208, a similarity score calculation module 210, and an F-divergence selection module 212. The similarity score calculation module 210 may further include a mean calculation module 214.

In some embodiment, a first sentence and a second sentence may be received by the computing device 102 for computation of similarity between these sentences. It will be apparent that two sentences are considered for convenience of explanation, however, the similarity may be determined between two paragraphs, pages, or whole documents as well.

Once the first sentence and the second sentence are received, the transformation module 202 may transform a plurality of words in each of the first sentence and second sentence into word embeddings. Word embeddings for a word may be a representation of the word as vectors in a multi-dimensional space. It should be noted that words with similar meanings and contexts are represented by similar vectors. The transformation from words to vectors may be done by using any existing algorithms, such as, but not limited to Word2vec, GloVe, fasText, ELMo, or the like. In some embodiments, the Bert model may be used for word embeddings. Bert model is a transformers model pertained in a self-supervised manner on a large corpus of English data for two main objectives: Masked Language modeling (MLM) and Next Sentence Prediction (NSP).

The probability distribution module 204 may normalize each of the plurality of word embeddings into the associated probability distributions. The probability distribution module 204 may use a predefined function to normalize the word embedding into a plurality of probability distributions. The predefined function, for example, may but is not limited to the Softmax function. The Softmax function converts a vector of raw scores into probabilities by taking an exponential of each score and normalizing them so that the sum of each score equals 1. For example, for an exemplary vector z=[z1, z2, z3, . . . zn], the Softmax function computes the probability distribution using the equation 1 given below:

$$σ ( {z}_{i} ) = \frac{{e}^{z} i}{{\sum }_{j = 1}^{n} {e}^{{z}_{j}}} \qquad ( 1 )$$

Once probability distribution for each of the plurality of word embeddings is determined, the pair-wise divergence value calculation module 206 may compute a pair-wise divergence value of each word of the first sentence relative to each word of the sentence using an F-divergence. The F-divergence method may be selected from a plurality of F-divergence methods. The divergence measure (or similarity) and associated properties depend on the choice of the F-divergence method that is selected. It should be noted that the pair-wise divergence value is computed using the probability distribution of each word of the first sentence relative to each word of the second sentence. In other words, the pair-wise divergence values may be calculated for all word-pair embeddings of the first sentence and the second sentence.

F-divergence methods (also known as Csiszar-Morimoto divergence) are a broader framework in terms of measuring how different two probability distributions are. Examples of F-divergence methods may include but are not limited to Kullback-Leibler (KL) divergence, Jenson-Shannon (JS) divergence, Total Variation distance, Hellinger distance, or the like.

In some embodiments, F-divergence may be defined using the equation 2 given below:

$${D}_{f} ( P \vert \vert Q ) ≡ {\int }_{Ω} f ( \frac{d P}{d Q} ) dQ \qquad ( 2 )$$

The JS divergence is a specific type of F-divergence method and is derived from F-divergence by selecting the function defined in equation 3 given below:

$$f ( t ) = \frac{1}{2} ( tlnt - ( t + 1 ) ln ( \frac{t + 1}{2} ) ) \qquad ( 3 )$$

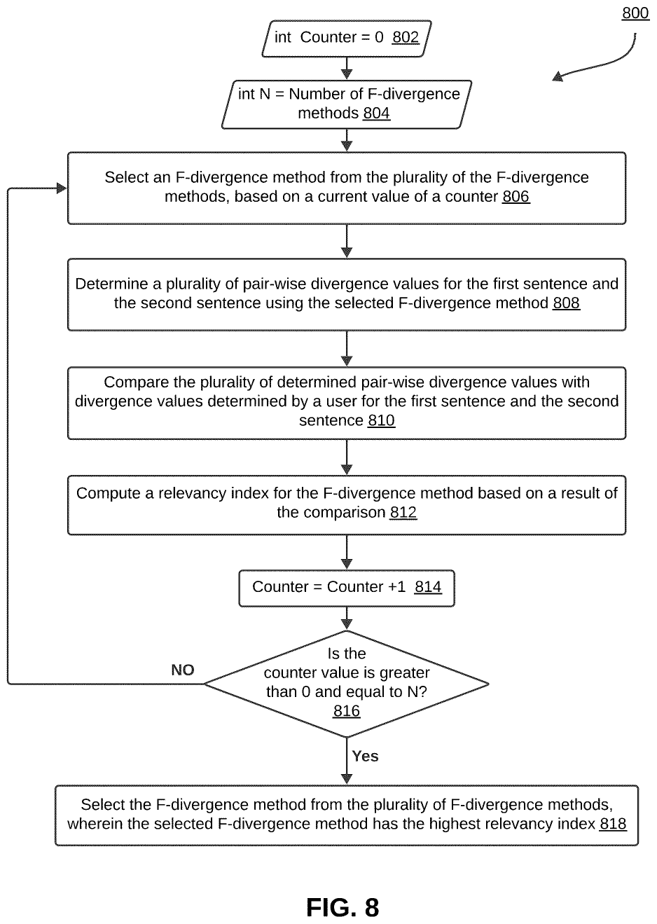

The F-divergence selection module 212 may identify the optimal F-divergence method from the plurality of F-divergence methods for the first sentence and the second sentence, based on a comparison between similarity scores computed using each of the plurality of F-divergence methods and human judgment data. The F-divergence selection module 212 computes a relevancy index for each of the plurality of F-divergence methods based on a result of the comparison. In conclusion, the F-divergence selection module 212 selects the F-divergence method from the plurality of F-divergence methods that have the highest computed relevancy index. This is further explained in detail in conjunction with the flowchart given in FIG. 8.

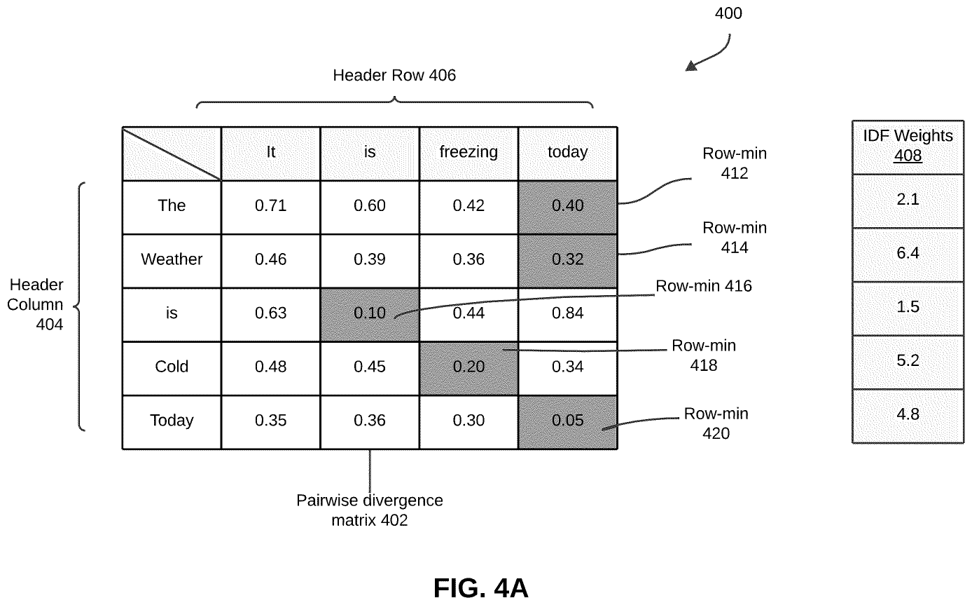

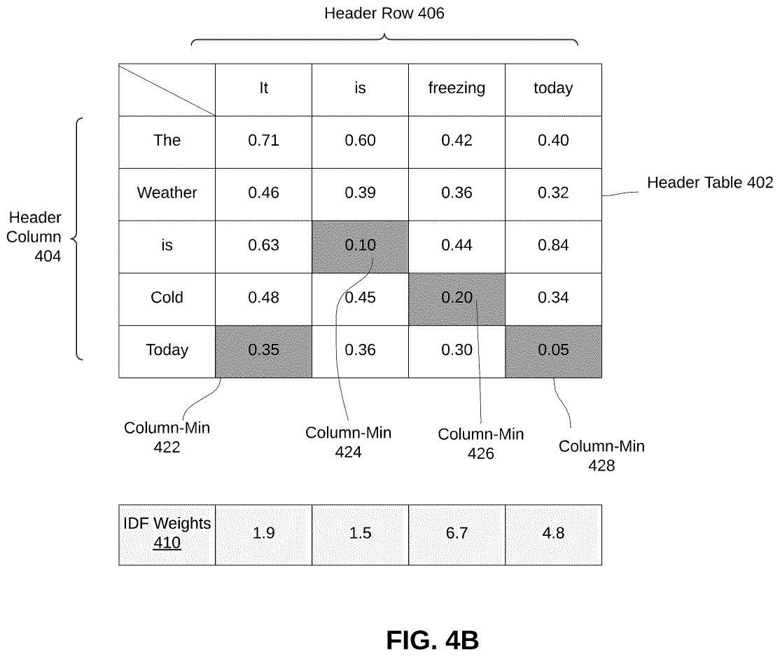

The pair-wise divergence matrix module 208 may create a pair-wise divergence matrix based on the computed pair-wise divergence values of each word of the first sentence relative to each of the words of the second sentence. It should be noted that the pair-wise divergence matrix is a two-dimensional matrix. The pair-wise divergence matrix includes a header column that includes each of the words of the first sentence in a unique cell and a header row that includes each of the words of the second sentence in a unique cell. The pair-wise divergence matrix module 208 may further list the computed pair-wise divergence value of each word of the first sentence relative to each word of the second sentence in an intersecting cell of the pair-wise divergence matrix. It should be noted that the intersecting cell is an intersection between a row associated with a first word of the header column and a column associated with a second word of the header row. This is further explained in detail in conjunction with FIG. 4A.

Thereafter, the similarity score calculation module 210 calculates the similarity score between the first sentence and the second sentence based on the pair-wise divergence matrix. For a given word of the first sentence, the similarity score calculation module 210 may identify a minimum divergence value from the plurality of divergence values in the row that corresponds to the given word in the pair-wise divergence matrix. The similarity score calculation module 210 may further include the mean calculation module 214 that may calculate the weighted mean of the pair-wise divergence values of words of each of the sentences as given in the pair-wise divergence matrix.

For each word of the first sentence, the mean calculation module 214 may identify a minimum divergence value from the plurality of divergence values in the corresponding row of the pair-wise divergence matrix. The mean calculation module 214 may determine a first weighted divergence value based on multiplication of the identified minimum divergence value with an associated weight, for each word of the first sentence. The mean calculation module 214 may then calculate a first weighted mean based on the first weighted divergence value determined for each word of the first sentence. Similarly, for each word of the second sentence, the mean calculation module 214 may identify a minimum divergence value from the plurality of divergence values in the corresponding column, for each word of the second sentence, in the pair-wise divergence matrix. The mean calculation module 214 may then determine a second weighted divergence value based on the multiplication of the identified minimum divergence value with an associated weight, for each word of the second sentence. Based on the second weighted divergence value determined for each word of the second sentence, the mean calculation module 214 may calculate a second weighted mean. Thereafter, in order to calculate the similarity score between the first sentence and the second sentence, the similarity calculation module 210 may calculate a mean based on the first weighted mean and the second weighted mean. The mean, for example, maybe a simple average or a harmonic mean.

It should be noted that all such aforementioned modules 202-214 may be represented as a single module or a combination of different modules. Further, as will be appreciated by those skilled in the art, each of the modules 202-214 may reside, in whole or in parts, on one device or multiple devices in communication with each other. In some embodiments, each of the modules 202-214 may be implemented as a dedicated hardware circuit comprising custom application-specific integrated circuits (ASIC) or gate arrays, off-the-shelf semiconductors such as logic chips, transistors, or other discrete components. Each of the modules 202-214 may also be implemented in a programmable hardware device such as a field programmable gate array (FPGA), programmable array logic, programmable logic device, and so forth. Alternatively, each of the modules 202-214 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for determining similarity between sentences using a pair-wise divergence matrix. For example, the exemplary system 100 and the processor 104 may determine the similarity between sentences using a pair-wise divergence matrix by the processes discussed herein.

In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by one or more processors on the system 100 to perform some or all of the techniques described herein. Similarly, application-specific integrated circuits (ASICs) configured to perform some, or all of the processes described herein may be included in one or more processors on the system 100.

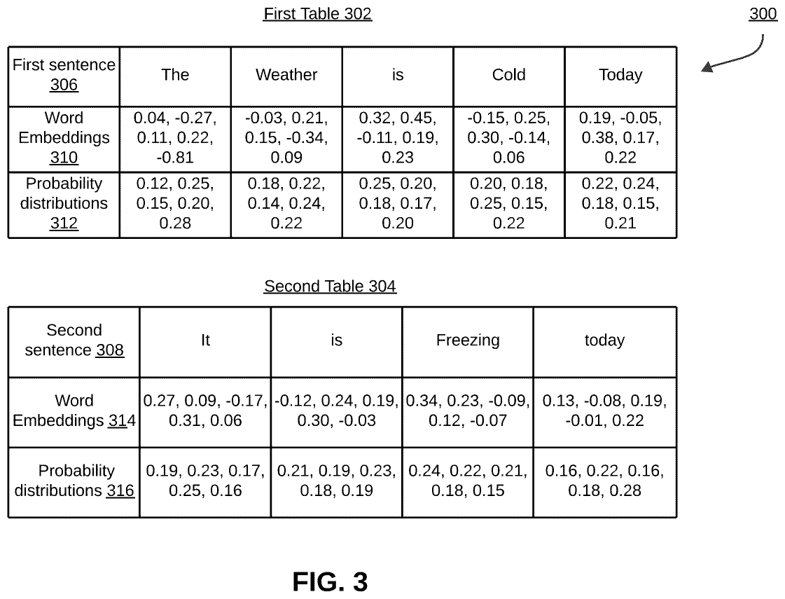

Referring now to FIG. 3, word embeddings and probability distribution for two sentences are illustrated, in accordance with an exemplary embodiment of the present disclosure. While a first table 302 includes word embeddings 310 and probability distributions 312 of each of the words of the first sentence 306, a second table 304 illustrates word embeddings 314 and probability distribution 316 of each of the words of the second sentence 308. Details in the first table 302 and the second table 304 may be used to determine similarity between the first sentence 306 and the second sentence 308. It may be noted that the word embeddings of each of the words of the first sentence 306 and the second sentence 308 may be calculated using a predefined word-to-embedding calculation function, such as, but not limited to Word2Vec, GloVe, or the like.

With regards to the first table 302, the header row of the first table 302 includes each of the words of the first sentence 306 in a unique cell of the first table 302. The second row of the first table 302 includes the word embeddings 310 for each of the words of the first sentence 306, while the third row of the first table 302 includes the probability distributions 312 of each of the words of the first sentence 306.

Similarly, with regards to the second table 304, the header row includes each of the words of the second sentence 308 in a unique cell of the second table 304. The second row of the second table 304 includes the word embeddings 314 for each of the words of the second sentence 308, while the third row of the second table 304 includes the probability distribution 316 for each of the words of the second sentence 308.

As depicted in FIG. 3, the first sentence 306 is “The weather is cold today” so the words ‘The,’ ‘weather,’ ‘is,’ ‘cold,’ and ‘today’ are placed distinctly in the first table 302 in a unique cell of the header row. The word embeddings 310 for a given word are calculated and placed in the same column as the given word. Similarly, the probability distribution 312 for a given word is calculated using the word embeddings 310 calculated for the given word. The probability distribution 312 is then placed in the same column as the given word. By way of an example, for the word “The,” the word embeddings 310 “0.04, −0.27, 0.11, 0.22, −0.81” and the probability distributions 312 “0.12, 0.25, 0.15, 0.20, 0.28” are placed in the column for the word ‘The’.

Further as depicted in FIG. 3, the second sentence 308 is “It is freezing today” so the words ‘It, ‘is’, ‘freezing, and ‘today’ are placed distinctly in the second table 304 in a unique cell of the header column. The word embedding 314 for a given word are calculated and placed in the same column as the given word. Similarly, the probability distribution 316 for a given word is calculated using the word embeddings 314 calculated for the given word. The probability distribution 316 is then placed in the same row as the given word. For example, for the word ‘It’, the word embeddings 314 are “0.27, 0.09, −0.17, 0.31, 0.06” and the probability distribution 316 “0.19, 0.23, 0.17, 0.25, 0.16” are placed in the same column for the word ‘It’.

Referring now to FIGS. 4A-B a pair-wise divergence matrix 402 created for two sentences the first sentence 306 and the second sentence 308 is illustrated, in accordance with an exemplary embodiment of the present disclosure, in conjunction with FIG. 3. The pair-wise divergence matrix 402 is created based on the computed plurality of pair-wise divergence values of each of the words of the first sentence 306 relative to each of the words of the second sentence 308. In an embodiment, a header column 404 of the pair-wise divergence matrix 402 includes each word of the first sentence 306 in a unique cell, while a header row 406 of the pair-wise divergence matrix 402 includes each word of the second sentence 308 in a unique cell. In an embodiment, the pair-wise divergence matrix 402 includes the computed pair-wise divergence value of each word of the first sentence 306 relative to each word of the second sentence 308 in an intersecting cell of the pair-wise divergence matrix 402. It should be noted that the intersecting cell is an intersection between a row associated with a first word of the header column 404 and a column associated with a second word of the header row 406. For each of the words of the first sentence 306 and the second sentence 308, a plurality of weights is assigned using a predefined weighting technique. The weighting techniques may include but are not limited to Inverse Document Frequency (IDF) weights, BM25, Attention weights, or the like. In an embodiment, the weights assigned to each word of the first sentence 306 and the second sentence 308 are determined using IDF as the weighting technique. IDF weights are statistical weights that measure how important a term is in a collection of documents. An IDF weights 408 determined for each of the words of the first sentence 306 are illustrated in FIG. 4A. Similarly, an IDF weights 410 determined for each of the words of the second sentence 308 are illustrated in FIG. 4B. The IDF weights 408 and the IDF weights 410, that corresponds to the importance of a term in a document, are determined using the IDF weighting technique that uses Term Frequency and Inverse Document Frequency as given in the equation 4 given below:

$$IDF ( Inverse Document Frequency ) = log ( \frac{Number of the documents in the corpus}{Number of documents in the corpus contain the term} ) \qquad ( 4 )$$

In the pair-wise divergence matrix 402, for each of the words of the first sentence 306 and for each of the words of the second sentence 308, a minimum pair-wise-divergence value is identified from a plurality of pair-wise divergence values determined. The minimum pair-wise divergence value represents the greater similarity between two words.

As depicted in FIG. 4A, for each of the words of the first sentence 306, the minimum pair-wise divergence value from the plurality of pair-wise divergence values is determined in the corresponding row of the pair-wise divergence matrix 402. For example, the minimum pair-wise divergence value for the first word “The,” of the first sentence 306 is “0.40” as depicted by a row-min 412. The row-min 412 represents the pair-wise divergence value determined for the first word “The” relative to the word “Today” of the second sentence 308.

Similarly, for each of the words of the first sentence 306, the minimum pair-wise divergence value from the plurality of pair-wise divergence values is determined in the corresponding row of the pair-wise divergence matrix 402. For example, the minimum pair-wise divergence value for the word “weather” of the first sentence 306 is “0.32” as depicted by a row-min 414. The row-min 414 represents the pair-wise divergence value determined for the second word “Weather” relative to the word “today” of the second sentence 308.

Further, the minimum pair-wise divergence value for the word “is” of the first sentence 306 is “0.10” as depicted by row-min 416. The row-min 416 represents the pair-wise divergence value determined for the third word “is” relative to the word “is” of the second sentence 308. Moreover, the minimum pair-wise divergence value for the word “cold” of the first sentence 306 is “0.20” as depicted by row-min 418. The row-min 418 represents the pair-wise divergence value determined for the fourth word “cold” relative to the word “freezing” of the second sentence 308. Similarly, the minimum pair-wise divergence value for the word “today” is “0.05” as depicted by row-min 420. The row-min 420 represents the pair-wise divergence value determined for the fifth word “today” relative to the word “today” of the second sentence 308.

Similarly, for each of the words of the second sentence 308, the minimum pair-wise divergence value from the plurality of pair-wise divergence values are determined in the corresponding column of the pair-wise divergence matrix 402. For example, the minimum pair-wise divergence value for the first word “It” of the second sentence 308 is “0.35” as depicted by column-min 422. The column-min 422 represents the pair-wise divergence value determined for the first word “It” relative to the word “today” of the first sentence 306. The minimum pair-wise divergence value for the second word “is” of the second sentence 308 is “0.10” as depicted by column-min 424. The column-min 424 represents the pair-wise divergence value determined for the second word “is” relative to the word “is” of the first sentence 306. Similarly, the minimum pair-wise divergence value for the third word “freezing” of the second sentence 308 is “0.20” as depicted by column-min 426. The column-min 426 represents the pair-wise divergence value determined for the third word “freezing” relative to the word “cold” of the first sentence 306. Similarly, the minimum pair-wise divergence value for the fourth word “today” of the second sentence 308 is “0.05” as depicted by column-min 428. The column-min 428 represents the pair-wise divergence value determined for the fourth word “today” relative to the word “today” of the first sentence 306.

In order to calculate similarity between the first sentence 306 and the second sentence 308, a plurality of steps is performed based on the pair-wise divergence matrix 402 and the associated IDF weights 408 and 410 of the words of the first sentence 306 and the second sentence 308. To this end, a first weighted mean is calculated based on the determined minimum pair-wise divergence values for each of the words of the first sentence 306. To calculate the first weighted mean, the determined minimum pair-wise divergence value of each word of the first sentence 306 is multiplied with the IDF weight associated with the word. Thereafter, an average of the result of the multiplication of the minimum pair-wise divergence values and the associated IDF weights of each of the words is calculated.

For example, the minimum pair-wise divergence value for the word “The” of the first sentence 306 is “0.40”, and the associated weight with the word “The” of the first sentence 306 is “2.1”. Thus, for the word “The”, the concluded multiplication is “0.84”. Similarly, the minimum pair-wise divergence value for the word “weather” of the first sentence 306 is “0.32”, and the associated weight with the word “weather” of the first sentence 306 is “6.3”. Thus, for the word “weather”, the concluded multiplication is “2.02”. The minimum pair-wise divergence value for the word “is” of the first sentence 306 is “0.1”, and the associated weight with the word “is” of the first sentence 306 is “1.5”. Thus, for the word “is”, the concluded multiplication is “0.15”. The minimum pair-wise divergence value for the word “cold” of the first sentence 306 is “0.2”, and the associated weight with the word “cold” of the first sentence 306 is “5.2”. Thus, for the word “cold”, the concluded multiplication is “1.04”. Similarly, the minimum pair-wise divergence value for the word “today” of the first sentence 306 is “0.05”, and the associated weight with the word “today” of the first sentence 306 is “4.8”. Thus, for the word “weather”, the concluded multiplication is “0.24”. Now, the associated first weighted mean for all the words in the first sentence 306 is determined using the equation 5 given below:

$$First Weighted Mean = \frac{( 0.84 + 2.02 + 0.15 + 1.04 + 0.24 )}{( 2.1 + 6.3 + 1.5 + 5.2 + 4.8 )} = 0.2 \qquad ( 5 )$$

Similarly, a second weighted mean is calculated based on the determined minimum pair-wise divergence values for each of the words of the second sentence 308. The second weighted mean calculation may include multiplying the determined minimum pair-wise divergence value of each of the words of the second sentence 308, with the associated IDF weight of the word.

For example, the minimum pair-wise divergence value for the word “It” of the second sentence 308 is “0.35”, and the associated weight with the word “It” of the second sentence 308 is “1.9”. Thus, for the word “It”, the concluded multiplication is “0.67”. Similarly, the minimum pair-wise divergence value for the word “is” of the second sentence 308 is “0.1”, and the associated weight with the word “is” of the second sentence 308 is “1.5”. Thus, for the word “is”, the concluded multiplication is “0.15”. The minimum pair-wise divergence value for the word “freezing” of the second sentence 308 is “0.2”, and the associated weight with the word “freezing” of the second sentence 308 is “6.7”. Thus, for the word “freezing”, the concluded multiplication is “1.34”. Further, the minimum pair-wise divergence value for the word “today” of the second sentence 308 is “0.05”, and the associated weight with the word “today” of the second sentence 308 is “4.8”. Thus, for the word “today”, the concluded multiplication is “0.24”. Now, the associated second weighted mean for all the words in the second sentence 308 is determined using the equation 6 given below:

$$Second Weighted Mean = \frac{( 0.67 + 0.15 + 1.34 + 0.24 )}{( 1.9 + 1.5 + 67 + 4.8 )} = 0.16 \qquad ( 6 )$$

In conclusion, a similarity score is calculated based on the calculated first weighted mean and the second weighted mean. In some embodiments, the similarity score may be calculated using a harmonic mean of the first weighted mean and the second weighted mean. The similarity score is computed using equation 7 given below:

$$( 7 )$$

$$The similarity score = \frac{2 * first weighted mean * second weighted mean}{first weighted mean + second weighted mean} = \frac{2 * \text{.22} * 0.16}{0.22 + 0.16} == 0.19$$

In conclusion, the calculated similarity score for the first sentence 306 and the second sentence 308 using the first weighted mean and the second weighted mean is “0.19” representing the similarity between the first sentence 306 and the second sentence 308. The similarity score of “0.19” thus indicates that context conveyed by the first sentence 306 and the second sentence 308 is very similar. In other words, nearer is the similarity score for given sentences to zero, more similar are these sentences to each other.

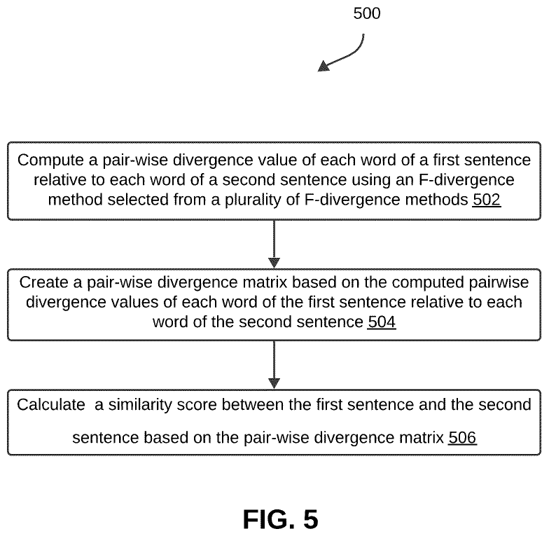

Referring now to FIG. 5, a flowchart 500 of a method fordetermining similarity between sentences using a pair-wise divergence matrix 402 is illustrated, in accordance with an exemplary embodiment of the present disclosure. In an embodiment, the method may include a plurality of steps. Each step of the flowchart 500 may be executed by various modules in the computing device 102, so as to determine the similarity between sentences using a pair-wise divergence matrix 402.

At step 502, a pair-wise divergence value of each word of a first sentence 306 relative to each word of a second sentence is computed using an F-divergence method. The F-divergence method is selected from a plurality of F-divergence methods based on the computed pair-wise divergence values of each word of the first sentence 306 relative to each word of the second sentence 308. A pair-wise divergence matrix 402 is created at step 504. Furthermore, the method calculates a similarity score between the first sentence 306 and the second sentence 308 based on the pair-wise divergence matrix 402 at step 506. This has already been explained in detail in conjunction with FIG. 2, FIG. 3, and FIGS. 4A and 4B.

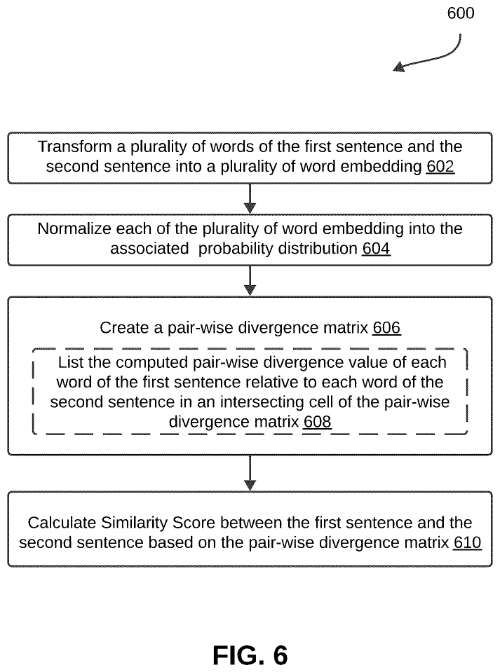

Referring now to FIG. 6, another flowchart 600 of a method of determining similarity between sentences using a pair-wise divergence matrix 402 is illustrated, in accordance with an exemplary embodiment of the present disclosure. In an embodiment, the method may include a plurality of steps. Each step of the flowchart 600 may be executed by various modules in the computing device 102, so as to determine the similarity between sentences using a pair-wise divergence matrix 402.

In an embodiment, in the flowchart 600, a plurality of words of the first sentence 306 and the second sentence 308 may be transformed into a plurality of word embedding at step 602. Further, at step 604, each of the plurality of word embeddings may be normalized into the associated probability distribution. At step 606, a pair-wise divergence matrix 402 may be created. Creating the pair-wise matrix 402 may include includes listing the computed pair-wise divergence value of each word of the first sentence 306 relative to each word of the second sentence 308 in an intersecting cell of the pair-wise divergence matrix 402 at step 608. Thereafter, at step 610, a similarity score between the first sentence 306 and the second sentence 308 may be calculated based on the pair-wise divergence matrix 402.

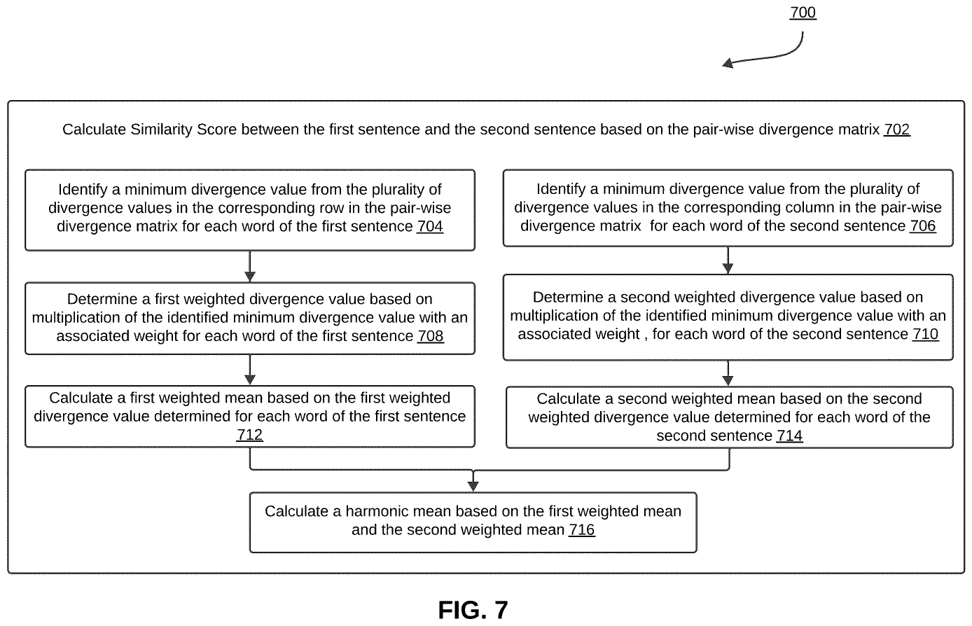

Referring now to FIG. 7, a flowchart 700 of a method of calculating similarity score between two sentences is illustrated, in accordance with an exemplary embodiment of the present disclosure. In an embodiment, the method may include a plurality of steps. Each step of the flowchart 700 may be executed by various modules in the computing device 102, so as to determine the similarity between sentences using a pair-wise divergence matrix 402.

In an embodiment, at step 702, a similarity score between the first sentence 306 and the second sentence 308 is calculated based on the pair-wise divergence matrix 402. The step 702 may be transformed into two separate processes that may be executed in parallel or consecutively by way of steps 704-714. In the first process, for each word of the first sentence 306, the step 702 may identify a minimum divergence value from the plurality of divergence values in the corresponding row in the pair-wise divergence matrix 402 at step 704. Simultaneously, at step 706, a minimum divergence value from the plurality of divergence values in the corresponding column in the pair-wise divergence matrix 402 may be identified for each word of the second sentence 308. At step 708, a first weighted divergence value based on the multiplication of the identified minimum divergence value with an associated weight may be determined for each word of the first sentence 306. Simultaneously, at step 710, a second weighted divergence value based on the multiplication of the identified minimum divergence value with an associated weight may be determined for each word of the second sentence 308.

At step 712, the first process may calculate a first weighted mean based on the first weighted divergence value determined for each word of the first sentence 306. Simultaneously, at step 714 the second process may calculate a second weighted mean based on the second weighted divergence value determined for each word of the second sentence 308. At step 716, the method may calculate a harmonic mean based on the first weighted mean and the second weighted mean, in conjunction with the step 712 and step 714.

Referring now to FIG. 8, a flow diagram 800 of a method for selecting an F-divergence method from a plurality of the F-divergence methods is illustrated, in accordance with an exemplary embodiment of the present disclosure. In an embodiment, the method may include a plurality of steps. Each step of the flowchart 800 may be executed by various modules in the computing device 102, so as to determine the similarity between sentences using a pair-wise divergence matrix 402.

It should be noted that the selected F-divergence method is from the plurality of the F-divergence methods and is optimal. To select the F-divergence method, at step 802, a counter that indicates one less than the current iteration is initiated at ‘0’. At step 804, a variable ‘N’ is assigned a value that is equal to the total number of F-divergence methods. (For example, if the total number of F-divergence methods is 5, then N=5).

At step 806, an F-divergence method is selected from the plurality of the F-divergence methods, based on a current value of a counter. Once an F-divergence method is selected, the method may further include determining a plurality of pair-wise divergence values for the first sentence 306 and the second sentence 308 using the selected F-divergence method at step 808. It should be noted that the pair-wise divergence values are determined based on creating a pair-wise divergence matrix 402. The method further may include comparing the plurality of determined pair-wise divergence values with divergence values determined by a user for the first sentence 306 and the second sentence 308 at step 810. In conclusion of the step 810, a relevancy index for the F-divergence method is computed based on a result of the comparison at step 812. The relevancy index indicates the similarity of closeness of an F-divergence method to the actual results determined by the user. The relevancy index may be calculated for each of the F-divergence method from the plurality of the F-divergence methods, using a predefined function such as but not limited to Spearman correlation, Pearson correlation, and the like. Each time an iteration completes the counter value is incremented by 1 at step 814.

At step 816, a check is performed to confirm if the counter value is greater than 0 and equal to ‘N.’. If the counter value is equal to 0, the control moves back to step 806. Steps from step 806 to 812 are then performed with another F-divergence method. However, if the counter value is greater than 0 and equal to ‘N’ the iteration terminates, and the best optimal F-divergence method is finally selected from the plurality of F-divergence methods at step 818. It should be noted that the final selected F-divergence method has the highest relevancy index. The final selected F-divergence may further be used to perform similarity determination between two sentences, in order to determine the optimized similarity between the first and second sentence 308.

Thus, the disclosed method for checking similarity between sentences is better than the existing solutions for the determination of sentence similarity. The disclosed method not only checks the similarity between sentences optimally but also works better in case of the presence of noise such as unnecessary characters or symbols. It should be also noted that the disclosed method not only checks the similarity between the lexically but also semantically. Hence, the disclosed method for checking the similarity between sentences is better than the existing solutions. We will be discussing the advantages of the disclosed method by way of some examples in more detail hereinafter.

Now, by way of some examples, the performance evaluation of the disclosed method on a plurality of sentences under different circumstances is shown hereinafter. The setup is done to evaluate the performance of disclosed method in determining the similarity between two sentences by including the same environment. The dataset for the sentences used here is STS benchmarking dataset. The STS benchmarking dataset typically consists of paired sentences, each assigned a similarity score on a continuous scale (for example 0-5). The Sample data of STS Benchmarking Dataset is depicted below in Table 1.

TABLE 1
Sample data of STS Benchmarking dataset

| S. | | | Sampled |
|---|---|---|---|
| No | Sentence1 | Sentence2 | Score |
| 1 | tirana is the capital of | abuja is the capital of | 1.0 |
| 2 | Suicide bomber kills 14 in | Suicide blast kills 1 in | 3.0 |
| | Afghanistan | Afghan capital | |
| 3 | Generations divided over | G20 Summit ends | 0.0 |
| | gay marriage | divided over Syria | |
| 4 | A car backs out of space | A car is taking revenge | 2.4 |
| 5 | terminal 1 is connected to | terminal 1 and 4 are | 5.0 |
| | terminal 4 | connected | |

Furthermore, by way of some examples, the comparison between the performance of the disclosed method as compared to some existing solutions for similarity determination between sentences is illustrated below.

By way of a first example, the representation of cases where the pair-wise divergence matrix 402 outperforms the existing method such as the cosine similarity method is depicted below. In ideal scenarios, for two sentences with human-annotated similarity scores is in the range of 4-5 (indicating high semantic similarity), the cosine similarity should be very high, while the Pair-wise divergence matrix 402 may be very low. However, instances were identified where the cosine similarity method fails to perform effectively (giving low similarity scores), while Pair-wise divergence continues to produce low divergence values, demonstrating its robustness.

To identify and analyze such cases, the following approach is employed. For each sampled similarity score in the range of 4-5, the mean and standard deviation of cosine similarity and JS divergence are computed. Records are filtered where the cosine similarity is less than the computed threshold for the respective score range, indicating suboptimal performance by cosine similarity. It should be noted that the threshold is mean-standard deviation. Among the filtered records, Pair-wise divergence values were also evaluated, and cases where Pair-wise divergence is below its respective threshold (mean-standard deviation), are further isolated. For example, the values of mean and standard deviation (for Sampled Score 4-5 sentences) are a Mean of the Pair-wise divergence is 0.018 and a Standard Deviation of the Pair-wise divergence is 0.00756. Similarly, the Mean of the Cosine similarity is 0.89 and the Standard Deviation of the Cosine Similarity is 0.0678. Now, based on the Mean-standard deviation values, the identified cases where Pair-wise divergence value is less than the calculated Mean-Standard deviation and the cosine similarity value is also less than the calculated Mean-Standard deviation, are depicted below in Table 2.

TABLE 2
Comparison between Pair-wise Divergence
and Cosine Similarity under noise

| | | | Pair-wise | Cosine |
|---|---|---|---|---|
| | | Sampled | divergence | Simi- |
| Sentence1 | Sentence2 | score | score | larity |
| What do we get | ------ ----------- What | 5 | 0.0092 | 0.6322 |
| in return for | do we get in return | | | |
| doing the | for doing the fighting | | | |
| fighting for | for them? | | | |
| them? | | | | |
| Breathe In, | buwhahahaha Breathe | 4.4 | 0.0097 | 0.8085 |
| Breathe Out, | In, Breathe Out, | | | |
| Move On. | Move On. | | | |
| Chairman of | Chairman of British | 4.2 | 0.0078 | 0.7204 |
| easyJet to step | no-frills airline | | | |
| down | easyJet to step down | | | |

Based on the examples and results of Table 2, the values of Cosine similarity drop significantly, reflecting a sensitivity to such noise. In contrast, Pair-wise divergence remains consistently low, showing its robustness and reliability in maintaining high correlation with semantic similarity. Additionally, there are no records found where cosine similarity is outperforming Pair-wise divergence.

Now, by way of a second example, the pair-wise divergence capturing semantic meaning better than cosine similarity is depicted below in Table 3. In an example, the behaviour of cosine similarity and Pair-wise Divergence under minor noise introduced into one of the sentences is investigated. In this example, a noise such as but not limited to extra characters, punctuations, and the like, are added to evaluate the better performance.

TABLE 3
Semantic similarity comparison under minor noise

| | | Pair-wise | |
|---|---|---|---|
| | | Divergence | Cosine |
| Sentence 1 | Sentence 2 | score | Similarity |
| Hi Venkat! | Hi Venkat! ---- ----- | 0.0091 | 0.7722 |
| What's up? | What's up? | | |
| The cat sat on | ufffffffffff The cat sat | 0.0041 | 0.6593 |
| the mat | on the mat | | |
| I love coding in | I _{——}_{——} love coding | 0.0110 | 0.7920 |
| Python. | in Python. | | |
| An apple a day, keeps | An apple a day, keeps | 0.0095 | 0.6716 |
| the doctor away | the doctor | | |
| | away!!!!!!!! | | |
| The weather is cold | blahblahblah!! The | 0.0101 | 0.6585 |
| today | weather is cold today | | |

Based on the observations of the examples in Table 3, in each of the cases, the cosine similarity values drop significantly, even though the introduced noise is minor and does not affect the semantic meaning of the sentences, indicating cosine similarity struggles to handle noise effectively and is overly sensitive to minor perturbations in sentences. In this way, the robustness of Pair-wise Divergence in recognizing that the sentences remain largely identical in meaning is demonstrated, despite superficial changes.

By way of a third example, the evaluation of the similarity measurement after the rearrangement of the sentences is depicted below in Table 4, to compare between the Pair-wise divergence and Cosine similarity. Rearrangement of the sentences may include but are not limited to the exchange of words, cycling shift of words, and the like. Table 4 is shown below containing examples of sentences having rearrangement of words.

TABLE 4
Similarity comparison after rearranging the words of the sentences

| | | Pair-wise | Cosine |
|---|---|---|---|
| Sentence 1 | Sentence 2 | JS Div score | similarity |
| An apple a day keeps | A doctor a day keeps | 0.016 | 0.945 |
| the doctor away | the apple away | | |
| The cat is on the mat | The mat is on the cat | 0.013 | 0.892 |
| Delhi is capital of | India is capital of | 0.016 | 0.911 |
| India | Delhi | | |
| The cat is on the mat. | The mat the cat is on. | 0.019 | 0.865 |
| The chicken crossed | Get to the other side | 0.021 | 0.860 |
| the road to get to the | The chicken crossed | | |
| other side. | the road to. | | |

As demonstrated in Table 4, in all the mentioned cases, even though the meaning has changed after rearrangement, cosine similarity has failed to capture this semantic meaning and shows a high similarity score. The Pair-wise Divergence is not only limited to just considering the corpus of words used but also understanding the semantic meaning of the sentence to score the similarity between sentences.

By way of a fourth example, the comparison of Pair-wise divergence and Cosine similarity in email and subject line is depicted below in Table 5. By comparing the email and subject line of the email, the effectiveness of cosine similarity and Pair-wise Divergence in identifying the correct subject line of an email among six variants, one correct subject line with some noise, and five random variants. The objective is to assess whether the methods can reliably rank the correct subject line higher (lesser numbered rank) than the noisy alternatives. For example, for each email, the correct subject line with slight noise added is paired, and five random variants, that are not as effective as the original subject line. The objective is to test the ability of cosine similarity and Pair-wise divergence to rank the correct subject line with slight noise among the random variants by placing it in the top 3 results. Rankings are computed based on the similarity or dissimilarity scores produced by the methods. The number of samples of the correct subject line with slight noise that appears in the top 3 ranked results is recorded for each method. The results are depicted below in Table 5.

TABLE 5
Email and subject line comparison

| | Pair-wise | Cosine | Absolute |
|---|---|---|---|
| | Divergence | Similarity | change |
| top_3 | 24 | 17 | 41.18% |
| top_2 | 17 | 11 | 54.55% |
| top_1 | 12 | 8 | 50.00% |

Based on the observation of the table 5, the Pair-wise divergence ranks the correct subject line in the top 3 for 24 samples among 50 samples, representing a 41% improvement over cosine similarity. The cosine similarity struggles to reliably identify the correct subject line among the variants. In this way, the robustness in handling minor textual perturbations while maintaining focus on semantic meaning of the Pair-wise Divergence is demonstrated. The Cosine similarity often ranks other variants higher than the correct subject line, reflecting its sensitivity to surface-level textual features rather than semantic relationships.

Using the method defined earlier, various methods of F-Divergence were computed for the dataset. To assess the alignment of these methods with human judgment data, the correlation between each F-divergence method and the human-annotated similarity scores are calculated. A higher correlation value indicates a closer alignment of the metric with human judgment data. The results of the comparison are as shown in Table 6.

TABLE 6
Comparison between various methods

| | Absolute |
|---|---|
| | Correlation with |
| Methods | Human Judgement |
| Pair-wise JS Divergence Score | 0.505488 |
| Cosine Similarity | 0.504017 |
| Pair-wise KL Divergence Score | 0.499900 |
| Pair-wise Pearson Chi Squared Divergence Score | 0.499877 |
| Pair-wise Hellinger Divergence Score | 0.478869 |
| Pair-wise Total Variation Distance Score | 0.474147 |

It should be noted that in the comparison Table 6, all the pair-wise divergence scores are calculated Pair-wise, and cosine similarity is calculated by simply using the dot product of the sentence's embeddings. Based on the comparison in Table 6, the Spearman correlation coefficients, representing the relationship between pair-wise divergence scores and human-annotated similarity scores, reveal that Pair-wise Divergence performs comparably to cosine similarity in terms of alignment with human judgments. This suggests that Pair-wise Divergence is a viable method for evaluating semantic similarity when considering the correlation with human annotations.

In conclusion, the proposed Pair-wise Divergence method demonstrates good resilience and accuracy in evaluating sentence similarity, particularly in noisy environments and rearrangement of words, where traditional metrics like cosine similarity fail. Pair-wise divergence uses word embedding comparisons to better capture semantic relationships and closely match human judgment.

The experimental results validate the robustness of the metric, showing a higher comparable correlation with human-annotated similarity scores than cosine similarity and other F-Divergence methods. Additionally, the ability of the Pair-wise divergence method to maintain accuracy in challenging cases highlights its potential to outperform traditional approaches in real-world applications.

The disclosed method not only sets a foundation for improved textual data analysis but also opens doors for developing advanced tools in areas such as natural language understanding, recommendation systems, and content analysis. Its ability to handle noisy data with minimal preprocessing makes the Pair-wise divergence a valuable contribution to the domain of semantic similarity measurement.

Thus, the disclosed method tries to overcome the technical problem of determining the similarity between sentences using a pair-wise divergence matrix 402. In an embodiment, advantages of the disclosed method and system may include but are not limited to measuring the similarity between which performs better than the existing matrix 402 under noise, selecting the most relevant subject line, providing a foundation for developing new tools and applications in industries reliant on texture data analysis.

The disclosed method and system significantly reduce the manual effort required by automating and determining the similarity between two or more sentences.

As will be appreciated by those skilled in the art, the techniques described in the various embodiments discussed above are not routine, conventional, or well-understood in the art. The techniques discussed above provide for determining the similarity between sentences using a pair-wise divergence matrix 402.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps bring an improvement in the functioning of the device itself as the claimed steps provide a technical solution to a technical problem.

The specification has described a method and system for determining similarity between sentences using a pair-wise divergence matrix 402. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor 104 to perform steps or stages consistent with the embodiments described herein. The term “computer-readable medium” should be understood to include tangible items and exclude carrier waves and transient signals, i.e., non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered exemplary only, with a true scope of disclosed embodiments being indicated by the following claims.

What is claimed is:

1. A method for determining similarity between sentences using a pair-wise divergence matrix, the method comprises:
computing, by a processor, a pair-wise divergence value of each word of a first sentence relative to each word of a second sentence using an F-divergence method selected from a plurality of F-divergence methods, wherein the pair-wise divergence value is computed using a probability distribution of each word of the first sentence relative to each word of the second sentence;
creating, by the processor, a pair-wise divergence matrix based on the computed pair-wise divergence values of each word of the first sentence relative to each word of the second sentence; and
calculating, by the processor, a similarity score between the first sentence and the second sentence based on the pair-wise divergence matrix.

2. The method of claim 1, further comprises transforming a plurality of words of the first sentence and the second sentence into a plurality of word embeddings.

3. The method of claim 2, further comprises normalizing each of the plurality of word embeddings into the associated probability distributions.

4. The method of claim 1, wherein a header column of the pair-wise divergence matrix comprises each word of the first sentence in a unique cell and a header row of the pair-wise divergence matrix comprises each word of the second sentence in a unique cell.

5. The method of claim 4, wherein creating the pair-wise divergence matrix comprises listing the computed pair-wise divergence value of each word of the first sentence relative to each word of the second sentence in an intersecting cell of the pair-wise divergence matrix, wherein the intersecting cell is an intersection between a row associated with a first word of the header column and a column associated with a second word of the header row.

6. The method of claim 1, wherein calculating the similarity score comprises:
identifying, for each word of the first sentence, a minimum divergence value from the plurality of divergence values in the corresponding row in the pair-wise divergence matrix;
determining, for each word of the first sentence, a first weighted divergence value based on the multiplication of the identified minimum divergence value with an associated weight; and
calculating a first weighted mean based on the first weighted divergence value determined for each word of the first sentence.

7. The method of claim 6, further comprises:
identifying, for each word of the second sentence, a minimum divergence value from the plurality of divergence values in the corresponding column in the pair-wise divergence matrix;
determining, for each word of the second sentence, a second weighted divergence value based on the multiplication of the identified minimum divergence value with an associated weight; and
calculating a second weighted mean based on the second weighted divergence value determined for each word of the second sentence.

8. The method of claim 7, wherein calculating the similarity score comprises calculating a harmonic mean based on the first weighted mean and the second weighted mean.

9. The method of claim 7, wherein the weight associated with each word of the first sentence and the second sentence is determined based on at least one of a plurality of weighting techniques.

10. The method of claim 1, further comprises:
identifying the F-divergence method from the plurality of F-divergence methods, wherein identifying the F-divergence method, comprises:
iteratively performing for the plurality of F-divergence methods:
selecting an F-divergence method from the plurality of the F-divergence methods, based on a current value of a counter;
determining a plurality of pair-wise divergence values for the first sentence and the second sentence using the selected F-divergence method;
comparing the plurality of determined pair-wise divergence values with divergence values determined by a user for the first sentence and the second sentence;
computing a relevancy index for the F-divergence method based on a result of the comparison; and
incrementing the current value of the counter by one, when the current value of the counter is less than the total number of the plurality of F-divergence methods; and
selecting the F-divergence method from the plurality of F-divergence methods, wherein the selected F-divergence method has the highest relevancy index.

11. A system for determining similarity between sentences using a pair-wise divergence matrix, the method comprises:
a processor; and
a memory communicably coupled to the processor, wherein the memory stores processor-executable instructions, which when executed by the processor, cause the processor to:
compute a pair-wise divergence value of each word of a first sentence relative to each word of a second sentence using an F-divergence method selected from a plurality of F-divergence methods, wherein the pair-wise divergence value is computed using a probability distribution of each word of the first sentence relative to each word of the second sentence;
create a pair-wise divergence matrix based on the computed pair-wise divergence values of each word of the first sentence relative to each word of the second sentence; and
calculate a similarity score between the first sentence and the second sentence based on the pair-wise divergence matrix.

12. The system of claim 1, wherein the processor-executable instructions further cause the processor to:
transform a plurality of words in the first sentence and the second sentence into a plurality of word embeddings.

13. The system of claim 2, wherein the processor-executable instructions further cause the processor to:
normalize each of the plurality of word embeddings into the associated probability distributions.

14. The system of claim 1, wherein a header column of the pair-wise divergence matrix comprises each word of the first sentence in a unique cell and a header row of the pair-wise divergence matrix comprises each word of the second sentence in a unique cell.

15. The system of claim 14, wherein creating the pair-wise divergence matrix further causes the processor to:
list the computed pair-wise divergence value of each word of the first sentence relative to each word of the second sentence in an intersecting cell of the pair-wise divergence matrix, wherein the intersecting cell is an intersection between a row associated with a first word of the header column and a column associated with a second word of the header row.

16. The system of claim 1, wherein the similarity score calculation further causes the processor to:
identify a minimum divergence value from the plurality of divergence values for each word of the first sentence, in the corresponding row in the pair-wise divergence matrix;
determine a first weighted divergence value based on the multiplication of the identified minimum divergence value with an associated weight for each word of the first sentence; and
calculate a first weighted mean based on the first weighted divergence value determined for each word of the first sentence.

17. The system of claim 16, wherein the processor-executable instructions further cause the processor to:
identify, for each word of the second sentence, a minimum divergence value from the plurality of divergence values in the corresponding column in the pair-wise divergence matrix;
determine, for each word of the second sentence, a second weighted divergence value based on the multiplication of the identified minimum divergence value with an associated weight; and
calculate a second weighted mean based on the second weighted divergence value determined for each word of the second sentence.

18. The system, of claim 17, wherein calculating the similarity score further causes the processor to calculate a harmonic mean based on the first and second weighted mean.

19. The system of claim 17, wherein the weight associated with each word of the first sentence and the second sentence is determined based on at least one of a plurality of weighting techniques.

20. The system of claim 11, wherein the processor-executable instructions further cause the processor to:
identify the F-divergence method from the plurality of F-divergence methods, wherein identifying the F-divergence method, comprises:
iteratively perform for the plurality of F-divergence methods:
select an F-divergence method from the plurality of the F-divergence methods, based on a current value of a counter;
determine a plurality of pair-wise divergence values for the first sentence and the second sentence using the selected F-divergence method;
compare the plurality of determined pair-wise divergence values with divergence values determined by a user for the first sentence and the second sentence;
compute a relevancy index for the F-divergence method based on a result of the comparison; and
increment the current value of the counter by one, when the current value of the counter is less than the total number of the plurality of F-divergence methods; and
select the F-divergence method from the plurality of F-divergence methods, wherein the selected F-divergence method has the highest relevancy index.
